(19) United States
(12) Patent Application Publication
(10) Pub. No.: US 2024/0103163 A1
(43) Pub. Date: Mar. 28, 2024

(54) FISH SPECIES DISCRIMINATION SYSTEM AND METHOD

(71) Applicant: Furuno Electric Co., Ltd., Nishinomiya (JP)

(72) Inventor: Tomoo WADA, Ashiya (JP)

(21) Appl. No.: 17/951,027

(22) Filed: Sep. 22, 2022

(51) Int. Cl. G01S 15/96; G01S 7/539

(52) U.S. Cl. CPC G01S 15/96; G01S 7/539

(57) ABSTRACT

A fish species discrimination system is provided with a signal receiver configured to receive a reflection signal from a water body, a data receiver configured to obtain fish information, and a user interface communicatively coupled to the data receiver, and configured to accept at least one user input related to at least one target fish. Further, the fish species discrimination system comprises processing circuitry communicatively coupled to the signal receiver, the data receiver, and the user interface. Further, the processing circuitry is configured to measure a depth of the at least one target fish, measure a size of the at least one target fish, and generate a display signal based at least on the depth and the size of the at least one target fish.

### TECHNICAL FIELD

The present disclosure relates to a fish species discrimination system and method for identifying target fish species within a water body.

### BACKGROUND

Typically, fish finders are used for detecting fish school and for discriminating fish species. The fish finder works on principle of ultrasound waves. Normally, the fish finder comprises of a transmitter and a receiver, where the transmitter is responsible to transmit ultrasound waves towards a water body where the fish species are to be detected. The transmitted ultrasound waves may be of varied intensities based upon area where the search is to be done. It should be noted that the tendency of sound waves is that, in case of an obstruction, the sound waves start to reflect back upon striking over an object. Such reflected back sound waves are thereby caught and processed by the receiver. Upon converting the sound waves into electronic signals, the fish finder is thereby able to determine the presence of the fish species in the water body. Although, this type of technology is successful enough to determine presence of the fish species but fails to distinguish or discriminate between the different fish species.

To target the specific fish species, discrimination among different fish species is a necessary task for a fisher man. Different target detection devices discriminate the fish species based on a historical dataset such as, size of a fish school, and a likely occurrence of a specific fish species at a certain depth inside the water body. However, to detect a specific fish kind and discriminate based on a shape and size is not possible using current target detection devices. Further, specifying only the fish kind is not enough to capture relevant fish species.

Therefore, there is a need for an improved and efficient fish species discrimination system capable of determining specific species of the fish.

### SUMMARY

An object of the present disclosure is to provide a fish species discrimination system, fish species discrimination method, and a non-transitory computer readable medium to detect and discriminate specific fish species accurately and efficiently. In one aspect, the present disclosure relates to a fish species discrimination system and a fish species discrimination method. The fish species discrimination system comprises a signal receiver configured to receive a reflection signal from a water body, a data receiver configured to obtain fish information, and a user interface communicatively coupled to the data receiver and configured to accept at least one user input related to at least one target fish. Further, the fish species discrimination system comprises processing circuitry communicatively coupled to the signal receiver, the data receiver, and the user interface. The processing circuitry is configured to measure a depth of the at least one target fish, measure a size of the at least one target fish, and generate a display signal based at least on the depth and the size of the at least one target fish.

The signal receiver may correspond to a transducer configured to transmit and receive the reflection signal from the water body.

The data receiver may correspond to a memory having a fish species database which is configured to store fish information such as fish species, fish size, and depth. The fish species database is further configured to contain at least one of a specific fish icon corresponding to the fish species, water temperature information at which the fish species live, area information and bottom sediment discrimination information where the fish species live.

According to this aspect, the fish species database is configured to be updated periodically, automatically, or randomly, using artificial intelligence or machine learning technology. In this aspect, the fish species database is configured to be updated manually based at least on a user input via the network. The at least one user input comprise at least one of depth and size of the at least one target fish.

In another aspect, the fish species discrimination system further comprises the data receiver configured to obtain fish species information and the user interface is further configured to accept at least one user input related to fish species. Further, the fish species discrimination system comprises the processing circuitry which is configured to discriminate fish species from the fish species information based at least on the depth and the size of the least one target fish, and generate a display signal based at least on the discrimination.

In this aspect, the fish species discrimination system may be configured to perform learning process for discriminating the fish species and identifying the fish species.

According to the present disclosure, the fish species discrimination system corresponds to at least one of fish finder or Sound navigation and Ranging (SONAR).

### BRIEF DESCRIPTION OF THE DRAWINGS

FIG. 1 is a schematic diagram showing a working environment of a fish species discrimination system, according to an embodiment of the present disclosure;

FIG. 2 is a schematic diagram showing transmitted and reflected ultrasound waves, according to an embodiment of the present disclosure;

FIG. 3 is a block diagram of the fish species discrimination system, according to an embodiment of the present disclosure;

FIG. 4 is a flowchart of a method for detection of at least one target fish, according to an embodiment of the present disclosure;

FIG. 5 is a flowchart of a method for discrimination of a fish species from a fish species information, according to an embodiment of the present disclosure;

FIGS. 6, 7, and 8 are tables representing characteristics features of the fish species, according to an embodiment of the present disclosure;

FIG. 9 is a Sound navigation and Ranging (SONAR) display showing a graphical analysis for one or more fish schools, according to an embodiment of the present disclosure;

FIG. 10 is fish finder display mode of the graphical analysis for a fish and the one or more fish schools, according to an embodiment of the present disclosure;

FIG. 11 shows an image representing elimination of non-target fish from detected fishes or the one or more fish schools, according to an embodiment of the present disclosure;

FIG. 12 is a sample display representing filtered images of the at least one target fish, according to an embodiment of the present disclosure;

FIG. 13 is a table showing fish marks corresponding to fish species, according to an embodiment of the present disclosure.

### DETAILED DESCRIPTION

Embodiments of the present disclosure will be described below with reference to the drawings. The same reference numerals are given to the same or corresponding parts in the figure, and the description thereof will not be repeated. At least some of the embodiments described below may be arbitrarily combined.

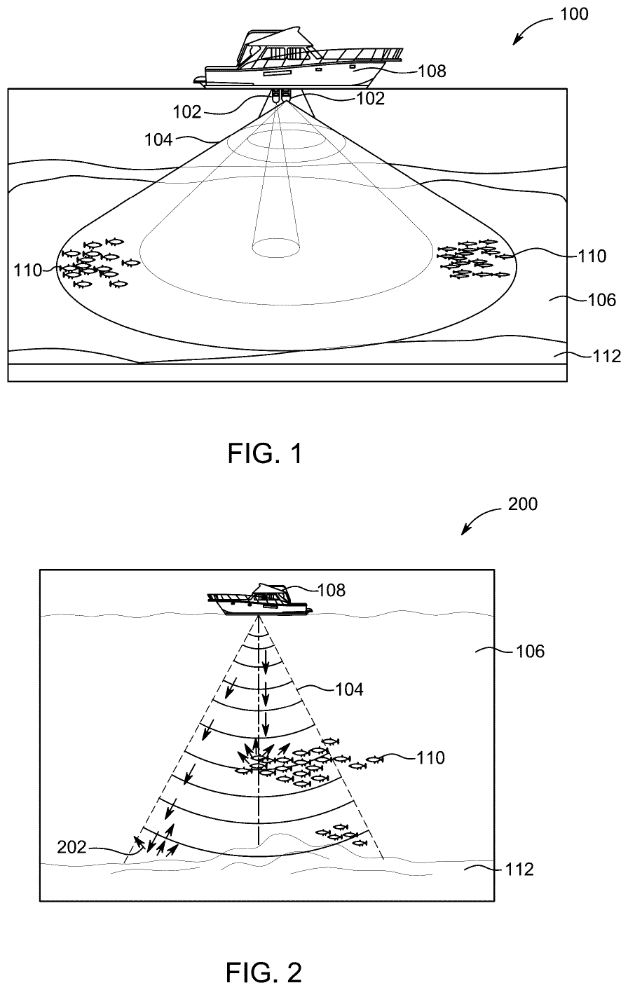

FIG. 1 is a schematic diagram 100 showing a working environment of a fish species discrimination system, according to an embodiment of the present disclosure.

Referring to FIG. 1, a transducer 102 configured to transmit and receive ultrasound waves 104 into a water body 106. It may be noted that the transducer 102 may be installed on a watercraft 108. The watercraft 108 may be any vehicle, capable of traversing in or on surface of the water body 106, such as a ship, a boat, a hovercraft, a submarine, or the like.

The transducer 102 may emit the ultrasound waves 104 towards the water body 106. Further, the ultrasound waves 104 may strike one or more fish schools 110 and a waterbed 112.

The one or more fish schools 110 may be a group of same or different kind fish swimming in a same direction, in a coordinated manner. The waterbed 112 may correspond to a bottom surface or a floor of the water body 106. The water body 106 may correspond to a part of an ocean, a sea, a lake, a pond, a river, or a reservoir where the watercraft 108 is discriminating the fish species.

The transducer 102 comprises a transmitter (not shown) and a receiver (not shown). The transmitter emits the ultrasound waves 104 towards the water body 106 and whenever, any obstacle comes, these ultrasound waves 104 start to reflect back. The emitted ultrasound waves 104 may be transmitted at multiple angles. For example, the transducer 102 transmits signals at wide angles such as ±50° or at narrow angles such as ±15° angles.

It can be noted that the obstacles may be in the form of the one or more fish schools 110 and the waterbed 112. It can also be noted that the waterbed 112 may correspond to a seabed or sea bottom. For example, the transducer 102 is a three-dimensional (3D) sound navigation and ranging (SONAR) that may perform 3D detection of the one or fish schools 110.

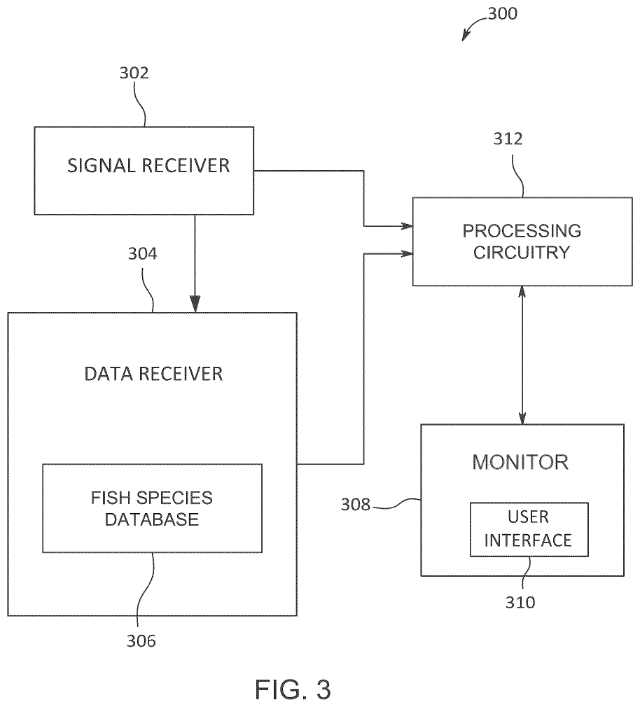

FIG. 2 is a schematic diagram showing reflected back ultrasound waves 104, according to an embodiment of the present disclosure.

Referring to FIG. 2, the reflected back ultrasound waves 104 may be termed as an echo 202. It can be noted that the reflected back ultrasound waves 104 may be transmission and return waves. The ultrasound waves 104 that strike the one or more fish schools 110 in the form of echo 202, may reflect back earlier in comparison to the ultrasound waves 104 reflecting back from the waterbed 112. The time interval between the emitted and reflected back ultrasound waves 104 aids in determining the distance of the one or more fish schools 110 and the waterbed 112.

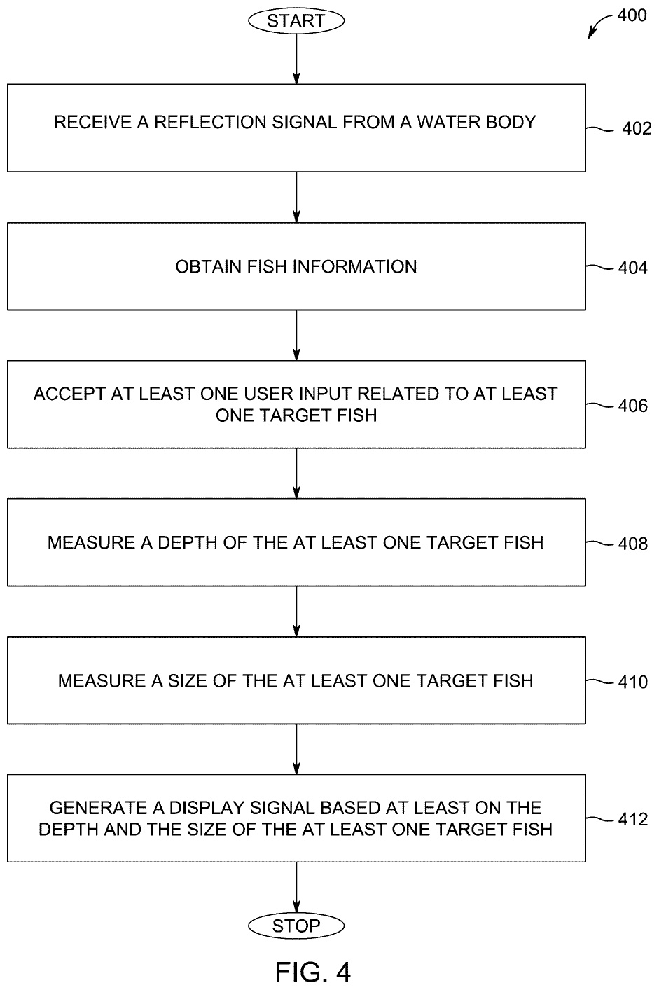

FIG. 3 is a block diagram of a fish species discrimination system 300, according to an embodiment of the present disclosure.

Referring to FIG. 3, the fish species discrimination system 300 comprises a signal receiver 302, a data receiver 304 having a fish species database 306, a monitor 308 having a user interface 310, and processing circuitry 312. It can be noted that the signal receiver 302, the data receiver 304 and the user interface 310 may be communicatively coupled with the processing circuitry 312.

The signal receiver 302 may correspond to the transducer 102 that emits the ultrasound waves 104 towards the water body 106. The emitted ultrasound waves 104 further gets reflected back from any obstructions present within the water body 106 in the form of the echo 202 (shown in FIG. 2). The echo 202 may further be processed by the signal receiver 302 in order to determine the presence and distance of the one or more fish schools 110 within the water body 106. The signal receiver 302 converts the echo 202 into a reflection signal 202.

The signal receiver 302 may detect the presence of the one or more fish schools 110 due to difference in density within the water body 106. It may be noted that an amount of gas in an air bladder of a fish may increase or decrease to regulate the buoyancy. Also, the gas inside the air bladder is having a drastically different density than the flesh and bone of the fish as well as the water that surrounds it. Such difference in density causes the echo 202 to bounce of the fish distinctively. Thus, the transducer 102 receives the echo 202 and the signal receiver 302 is able to recognize these differences to determine the presence of the one or more fish schools 110.

The data receiver 304 may correspond to a memory. The memory may be a space dedicated for saving data related to instructions, and commands. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium.

Further, the data receiver 304 may comprise a fish species database 306 that is constructed with a plurality of registers, where each register in the data receiver 304 is one storage location. The fish species database 306 may store fish information related to one or more characteristics of each fish species. Further, the fish information includes types of fish species such as, but not limited to, “Red Seabream”, “Rounded Cuttle Fish”, “Striped fish”, and “Tile fish”.

In an embodiment, the fish information may also include fish size such as size of the “Tile fish” to be 40 centimetres (cm), size of a “Yellowtail Amberjack” to be 50 cm etc. In an embodiment, the fish information may also include depth at which the fish species prefers to exist. For example, “Tile fish” is found at a depth of 200 meters and the “Yellowtail Amberjack” is found at a depth of between 10-30 meters.

In an embodiment, the fish information may also include a specific fish icon corresponding to the fish species, water temperature information at which the fish species live and area information where the fish species live, and bottom sediment discrimination information where the fish species live. The area information corresponds to geographical areas, such as the “Indian Ocean”, “Sea of Japan”, “Pacific Ocean”, “Persian Gulf”, “inside the Tokyo Bay”, or “near the USA”, etc. While the bottom sediment discrimination information means the bottom sediment information.

Further, the data receiver 304 may correspond to a communicator configured to receive the fish information from the fish species database 306 via a network. The network is at least one of Long Term Evolution (LTE), 5G, 6G, National Marine Electronics Association (NMEA) bus, Controller Area Network (CAN) Bus, Local Area Network (LAN), Internet, Wireless Fidelity (Wi-Fi), and satellite communication.

In an embodiment, the fish species database 306 may be configured to be updated periodically, automatically, or randomly, using an artificial intelligence or a machine learning technology, or manually by a user via the network.

The artificial intelligence or a machine learning technology may automatically update the fish species database 306 based upon a trained data set. It can be noted that the trained data set may include, but not limited to, real time determined depth and the size of the fish or the one or more fish schools 110, the characteristics of a new fish species, characteristics of a new location of the new or known fish and/or the one or more fish schools 110.

In an embodiment, the artificial intelligence or a machine learning technology based upon the trained data set may update the fish species information.

The trained data set helps the processing circuitry to discriminate the target fish more accurately among multiple fish species at different circumstances.

The different circumstances correspond to different conditions at which fish species discrimination is to be conducted such as different water level, different weather conditions, different visibility conditions, different types of oceans etc.

The user interface 310 may correspond to an input device that receives input instructions from a user. The user interface 310 may be communicatively coupled to the signal receiver 302 and may be configured to accept at least one user input related to at least one target fish and/or fish species.

In an embodiment, the user may be a fisherman, a pilot of the watercraft 108. The user interface 310 may either accept an input from the user or provide an output to the user or may perform both the actions.

For example, the user may give input regarding at least one target fish and/or fish species such as the “Tile fish”. In an embodiment, the user interface 310 may either be a Command Line Interface (CLI), Graphical user interface (GUI), or a voice interface.

Further, the user interface 310 may be installed within the monitor 308. In an embodiment, the monitor 308 may display results of the processed reflection signal 202 for determination of the one or more fish schools 110 and/or discrimination of fish species to the user.

The monitor 308 may be a touch screen that enables the user to select at least one target fish and/or fish species. In an embodiment, the touch screen may correspond to at least one of a resistive touch screen, capacitive touch screen, or a thermal touch screen.

The processing circuitry 312 may comprise suitable logic, circuitry, and/or interfaces that are operable to execute one or more instructions stored in the memory to perform predetermined operations. The processing circuitry 312 may be communicatively coupled with the signal receiver 302, the data receiver 304, and the user interface 310.

According to the aspect, the processing circuitry 312 may be configured to measure a depth of at least one target fish, measure a size of the at least one target fish, discriminate the fish species from the fish species information based at least on the depth and the size of the least one target fish, generate a display signal based at least on the depth and the size of the at least one target fish and also generate the display signal based at least on the discrimination over the user interface 310.

The processing circuitry 312 may examine and process an output information derived by the signal receiver 302 after processing the reflected echo 202 from the one or more fish schools 110. The output information may be the information about the presence of the one or more fish schools 110 by the signal receiver 302.

The processing circuitry 312 based upon the output information, determines the size and depth of the fishes present individually or in the one or more fish schools 110. The processing circuitry 312 evaluates the intensity of the reflection signal 202 bounced back from the fish or the one or more fish schools 110. The small size fishes may reflect low intensity reflection signal 202 whereas the large size fishes may reflect high intensity reflection signal 202.

Similarly, the processing circuitry 312 may determine the size of the one or more fish schools 110 based upon the intensity of the reflection signal 202.

Further, the processing circuitry 312 may determine the time duration between the reflected ultrasound waves 104 with the reflected back echo 202. The time duration aids the processing circuitry 312 to determine the depth of the individual fish or the one or more fish schools 110. It may be noted that larger time duration between the ultrasound waves 104 and the reflected back echo, corresponds to presence of the individual fish or the one or more fish schools deeper inside the water body 106.

Similarly, shorter time duration between the ultrasound waves 104 and the reflected back echo, corresponds to presence of the individual fish or the one or more fish schools 110 closer to a surface of the water body 106.

Further, the processing circuitry 312 may generate the display signal based at least on the depth and the size of the at least one target fish. The display signal may represent the presence of the target fish and/or the presence of the one or more fish schools 110, along with their respective size and depth.

The processing circuitry 312 may project the display signal over the user interface 310 for the user to determine the depth and the size of the fish and the one or more fish schools 110.

Further, the processing circuitry 312 may also determine the fish species of the target fish entered by the user over the user interface 310. The processing circuitry 312 utilizes the fish species information stored within the data receiver 304 to determine the fish species of the target fish. The processing circuitry 312 compares the depth and the size of the target fish as determined earlier, with the one or more characteristics of the fish species information.

For example, the determined depth and the size of Red Seabream determined by the processing circuitry 312 is 180 meters and 40 cm. In case of determining at least one fish species of similar or same depth and size, the processing circuitry 312 may determine the fish species kind of the at least one target fish and display over the user interface 310 for the user.

It may be noted that, the processing circuitry 312 may also compare other characteristics of the at least one target fish with the stored fish species information, to achieve accurate results. The processing circuitry 312 matches the bottom sediment, seabed structure, fish school position and temperature range of the at least one target fish with the stored fish species information.

The processing circuitry 312 may also correspond to a processor. The processor may be configured to execute one or more computer-readable program instructions, such as program instructions to carry out any of the functions described in this description.

Further, the processor may be implemented using one or more processor technologies known in the art. Examples of the processor include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In an embodiment, the processing circuitry 312 may be integrated with a controller. The controller is a processor, such as a CPU configured to read and execute a computer program.

The controller may control display modes of the images and the mark (s) displayed on the monitor 308. The “marks” over the monitor 308 corresponds to the unwanted elements. The unwanted elements may be referred as fish species that are not required by the user, other marine species or non-target species, other marine objects such that grains, stone, plants etc.

As described, the processing circuitry 312 may switch the display mode of each mark stored in the memory between “displayed” and “not displayed” on the monitor 308, based on the information acquired from the memory.

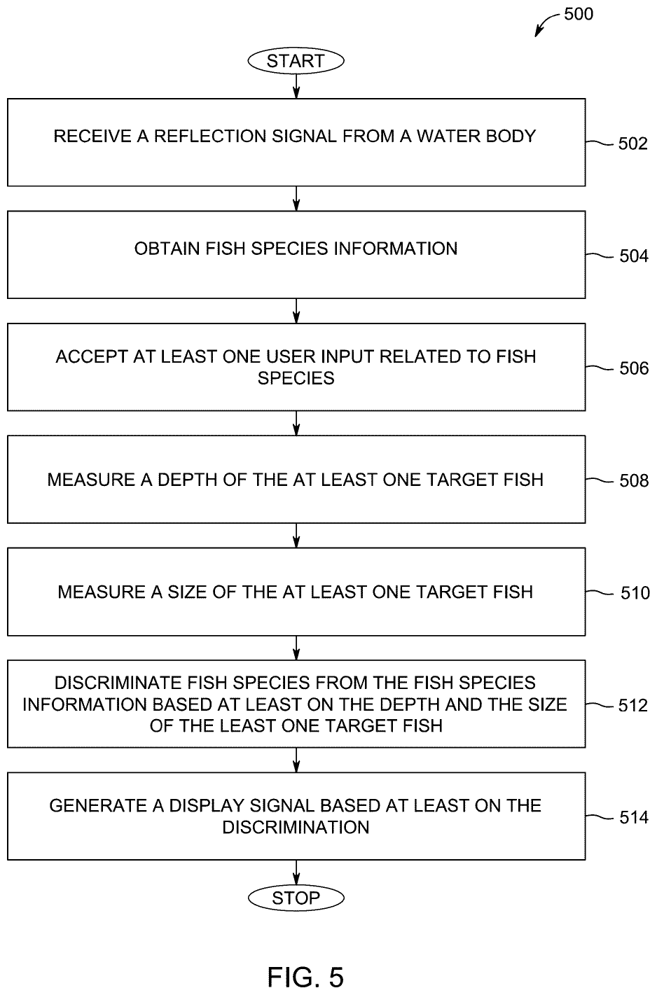

FIG. 4 is a flowchart of a method 400 of determining of the at least one target fish, according to an embodiment. FIG. 4 is described in conjunction with FIGS. 1, 2, and 3.

At first, the signal receiver 302 may receive the reflection signal 202 from the water body 106, (at step S402). The signal receiver 302 may emit the ultrasound waves 104 inside the water body 106. The ultrasound waves 104 may reflect from any obstruction within the water body 106 such as the one or more fish schools 110, individual fish and the waterbed 112. For example, the signal receiver 302 receives a reflected echo of 50 KHz from the water body 106, after transmitting an ultrasound signal of 70 KHz.

Further, the data receiver 304 may obtain the fish information, (at step S404). The fish information may correspond to information about the presence of the fish and the one or more fish schools 110 detected by the signal receiver 302. In another embodiment, the data receiver 304 may contain approximate number of fish and/or size of the one or more fish schools 110 based upon the intensity of the reflection signal 202 received by the signal receiver 302.

For example, the data receiver 304 obtains an arch from the reflected echo of 50 KHz that corresponds to detection of fish and the one or more fish schools 110.

Further, the user interface 310 may accept the at least one user input related to the at least one target fish, (at step S406).

The at least one target fish corresponds to the fish and/or the one or more fish schools 110 determined by the signal receiver 302.

For example, the user interface 310 accepts that the at least one user input is Red Seabream.

Further, the processing circuitry 312 may measure the depth of the at least one target fish selected by the user, (at step S408).

Further, the processing circuitry 312 may measure the size of the at least one target fish selected by the user, (at step S410).

The processing circuitry 312 may measure the size of the at least one target fish based on the at least one user input. The processing circuitry 312 may process the reflection signal 202 and based upon the intensity of the reflection signal 202, may determine the size of the at least one target fish. Similarly, based upon the time interval between the emitted ultrasound waves 104 and the received echo, the processing circuitry 312 may determine the depth of the at least one target fish.

For example, the processing circuitry measures that the Red Seabream selected by the user is having a size in a range of 20 cm to 50 cm and prefers to exist at a depth of between 20 cm to 40 cm.

Successively, the processing circuitry 312 may generate a display signal based at least on the depth and the size of the at least one target fish, (at step S412).

The processing circuitry 312 may generate graphs or infrared images over the user interface 310 that depict the presence of the al least one target fish. It may be noted that, the graph and or the infrared images may represent the determined at least one target fish in schematic formation and the size and clarity of the schematic representation may correspond to the size of the one or more target fish.

For example, the processing circuitry 312 generates an arch that are images of due to the presence of the fish or the one or more fish schools 110.

In an embodiment, the display signal may be illustrated against a graph shown in either left or right side of the monitor 308. The scale may be configured with distance scale in order to represent the depth of the one or more target fish for the user.

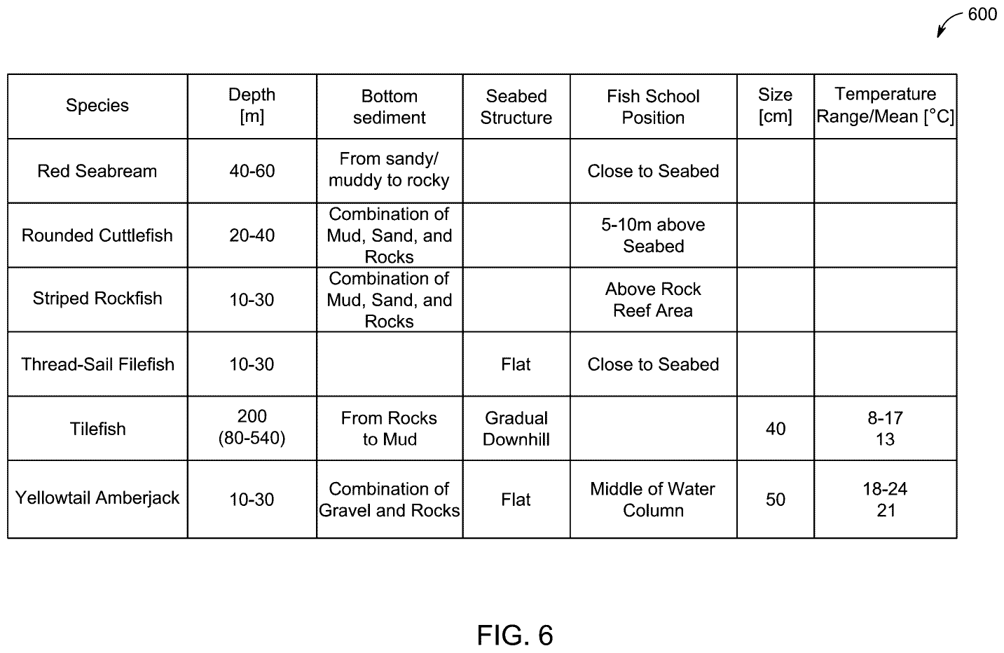

FIG. 5 is a flowchart 500 for a method for discrimination of a fish species from a fish species information. FIG. 5 is described in conjunction with FIGS. 1, 2, and 3.

At first, the signal receiver 302 may receive the reflection signal 202 from the water body 106, (at step S502). The signal receiver 302 may emit the ultrasound waves 104 inside the water body 106. The ultrasound waves 104 may reflect from any obstruction within the water body 106 such as the one or more fish schools 110, individual fish and the waterbed 112. It may be noted that all the obstructions may reflect the ultrasound waves 104 in the form of echo that may converted in the form of reflection signal 202 by the signal receiver 302.

For example, the signal receiver 302 receives a reflected echo of 50 KHz from the water body 106, after transmitting an ultrasound signal of 70 KHz.

Further, the data receiver 304 may obtain a fish species information, (at step S504). The data receiver 304 may configure with the fish species database 306. The fish species database 306 may store with the fish species information. The fish species information includes one or more characteristics of each fish species. For example, the fish species information includes fish species names such as “Red Seabream”, “Rounded Cuttle Fish”, “Striped fish”, “Tile fish”.

In an embodiment, the fish species information may also include fish size such as size of the “Tile fish” to be 40 centimetres (cm), size of a “Yellowtail Amberjack” to be 50 cm etc.

In an embodiment, the fish species information may also include depth of the fish such as, depth of the “Tile fish” to be 200 meters and depth of the “Yellowtail Amberjack” to be 10-30 meters etc.

In an embodiment, the fish species information may also include a specific fish icon corresponding to the fish species, water temperature information at which the fish species live and the area information where the fish species live, and the bottom sediment discrimination information where the fish species live.

Further, the user interface 310 may accept at least one user input related to fish species, (at step S506). The user may enter a name of the fish species that is required to be caught by the system.

For example, the user enters “Tile fish” as the fish species name for the target fish on the user interface 310.

It may be noted that, the user may give one or more inputs related to the target fish such as names of multiple fish species. For example, “Tile fish”, “Migratory fish”, “Olive founder”.

It may also be noted that the user my also enter other characteristics of the target fish, such as, details of bottom sediment, seabed structure, fish school position and temperature range/mean.

For example, to catch Tile fish, the user “Tile fish”, and further enters depth as “200 meters” and or enter temperature range as “8-17 degrees” for better results.

Further, the processing circuitry 312 may measure the depth of the at least one target fish, (at step S508).

Further, the processing circuitry 312 may measure the size of the at least one target fish, (at step S510).

For example, the processing circuitry 312 determines the depth of the at least one target fish as 180 meters and size of the at least one target fish as 38 cm.

It may be noted that the processing circuitry 312 may evaluate the intensity of the reflection signal 202 bounced back from the one or more target fish. The small size fishes may reflect low intensity reflection signal 202 whereas the large size fishes may reflect high intensity reflection signal 202.

Further, the processing circuitry 312 may discriminate fish species from the fish species information based at least on the depth and the size of the at least one target fish, (at step S512).

For example, the processing circuitry 312 compares the determine depth and the size of the one or more target fish that is 180 meters and 38 cm with the stored fish species information within the data receiver 304.

The processing circuitry 312 compares the depth and the size of the target fish as determined earlier, with the one or more characteristics of the fish species information. For example, the determined depth and the size of the target fish determined by the processing circuitry 312 needs to be 180 meters and 38 cm.

Further, the processing circuitry 312 may compare these results with the characteristics of the fish species saved within the data receiver 304.

In case of determining at least one fish species of similar or same depth and size, the processing circuitry 312 may determine the fish species (fish species name) of the at least one target fish. For example, here the depth and the size of the fish species “Tile fish” is 180 meters and 40 cm which is pre stored within the data receiver 304.

This is close or similar to the derived depth and size which was 180 meters and 38 cm. Thereby, in this manner, the processing circuitry 312 may conclude the identification of fish species “Tile fish” within the water body 106.

Successively, the processing circuitry 312 may generate a display signal based at least on the discrimination, (at step S514).

For example, the processing circuitry 312 communicates the determined, at least one target fish to the user over the monitor 308 in the form of a text written with species name, in the form of symbol representing the one or more target fish, in the form of identity number etc.

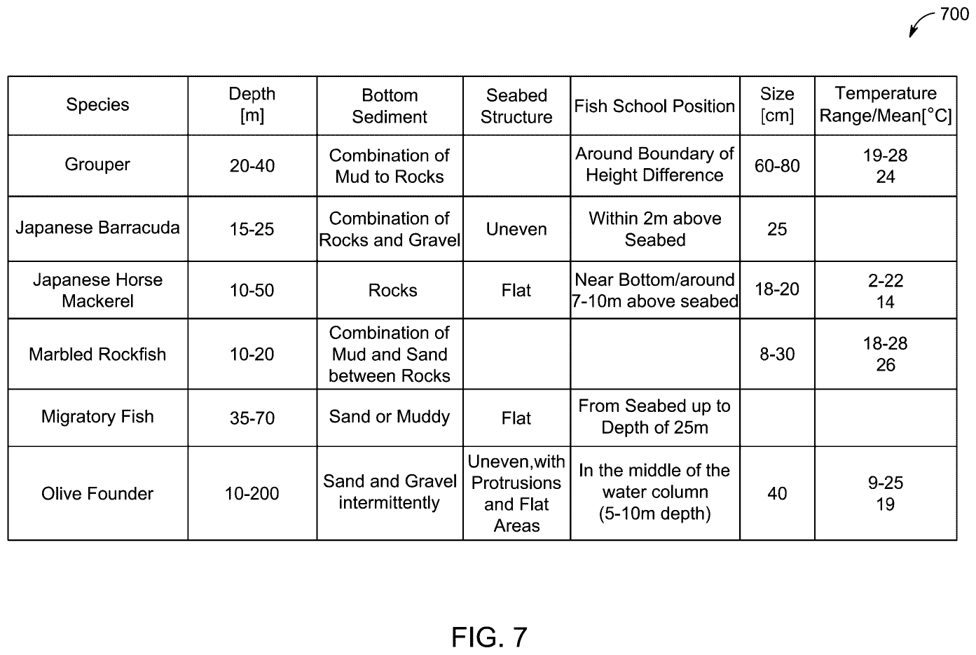

FIGS. 6, 7, and 8 are tables 600, 700, and 800 respectively, representing characteristics features of the fish species, according to an embodiment of the present disclosure.

These characteristic features mentioned in the tables are stored within the fish species database 306. The characteristics herein includes fish species name, depth of each species where they likely habitat, bottom sediment type where they likely habitat, seabed structure where they likely habitat, fish school position, approximate size of the individual fish and approximate temperature of the water where they likely habitat.

In one example, a Yellow Amberjack with a size of 50 cm prefers to live at a depth of 10-30 meters from a water surface, within a combination of rocks and gravel and have a flat seabed structure, with temperature range of 18 degrees Celsius to 24 degrees Celsius. In another example, Japanese Horse Mackerel with a size of between 18 cm to 20 cm, prefers to exist at a depth of between 10 meters to 50 meters within rocks and have a flat seabed structure with temperature range of 2 degrees Celsius to 22 degrees Celsius.

In another example, Green fish with a size in a range of 48 cm to 62 cm, prefers to exist at a depth of less than 5 meters from the surface water in a rough rugged terrain, close to seabed.

In another example, Chub Mackerel with a size of 25 cm, prefers to exist at a depth of between 50 cm to 200 cm with a changing bottom sediment between mud and rocks, and fish school position near middle and bottom strata.

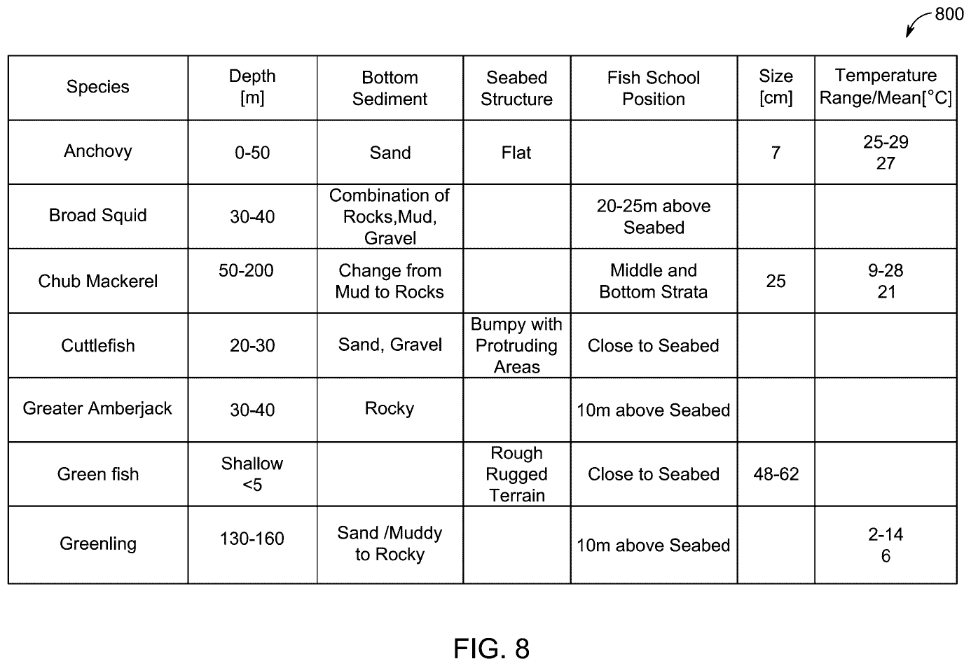

FIG. 9 shows a SONAR display 900 showing a graphical analysis for the one or more fish schools 110, according to an embodiment of the present disclosure. FIG. 9 is described in conjunction with FIGS. 1-8.

As explained earlier, the processing circuitry 312 may project the display signal to the user over the monitor 308 in different modes. The monitor 308 consists of a horizontal display mode 900 with the graphical analysis for location of the one or more fish schools 110 within the water body 106. For example, the monitor 308 shows horizontal 2-dimensional view of a target area where the one or more fish schools 110 are determined.

The monitor 308 shows the one or more fish schools 110, a watercraft position 902, a watercraft track 904, the waterbed 112, a sea current 906, a tilt angle 908 and a watercraft coordinates 910. The one or more fish schools 110 may be highlighted in patches. It may be noted that the intensity of these patches represents the size of the one or more fish schools 110 or the number of fishes within the one or more fish schools 110.

Further, a centre point of the graphical analysis depicts the location of the watercraft 108 as the watercraft position 902 helps in understanding the distance and location of the determined one or more fish schools 110 from the watercraft 108. It may be noted that a marked line through the watercraft position 902 represents the watercraft track 904 or the pathway followed by the watercraft 108. This helps in understanding the location of the one or more fish schools 110 in correlation to the watercraft track 904 and direction of the watercrafts 108.

Further, multiple curved lines around the watercraft position 902 shows the sea current 906. The sea current is a direction of flow of water that may predict direction of flow of the one or more fish schools 110.

Further, the tilt angle 908 and the watercraft coordinates 910 show an angle at which the watercraft 108 is positioned and geographical location of the watercraft 108. The tilt angle 908 may correspond to an azimuth angle to determine angular measurement of the watercraft position 902 with respect to the one or more fish schools 110.

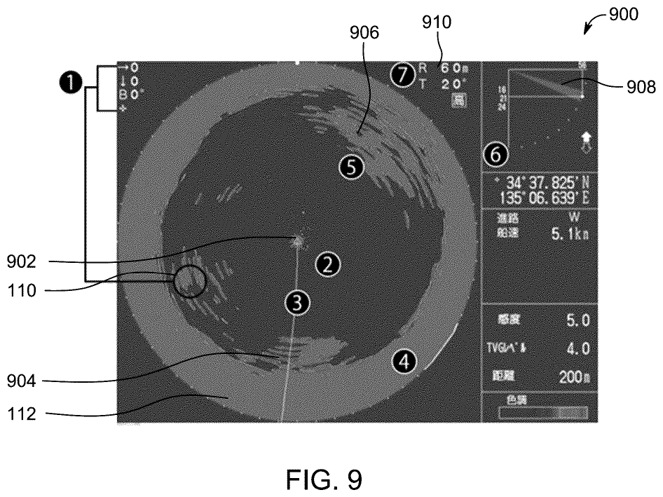

FIG. 10 is a fish finder display (mode) 1000 of the graphical analysis for a fish and the one or more fish schools 110, according to an embodiment of the present disclosure. FIG. 10 is described in conjunction with FIGS. 1-8.

Referring to FIG. 10, the fish finder display (mode) 1000 provides an unfiltered information about the presence of the one or more fish schools 110 in different orientation and nature. Further, multiple echoes (shown by 1002) correspond to the patches of the one or more fish schools 110 which are present nearby the waterbed 112.

Further, a scale 1004 is for determining the depth of the water body 106. As shown, the scale 1004 is marked from 0-50 meters.

The waterbed 112 is observed to be about 50 meters lower from a surface 1006 of the water body 106. A large size fish school 1008 may be about 30 metres from the waterbed 112. Similarly, between 30 metres to 10 metres distance, multiple single fishes 1010 may be spotted within the water body 106.

The multiple echoes (shown by 1002) analysed by the processing circuitry 312, may detect the presence of a fishing line 1012 along with aeration of the watercraft 1014 itself. The multiple echoes (shown by 1002), aids in helping a user to determine the depth at which the one or more fish schools 110 are present.

Further, between 20 metres to 10 meters' distance multiple planktons 1016 may be seen drifting along the water body 106.

It may be noted that graphical analysis in the fish finder display (mode) 1000, may be marked with a colour scale. The colour scale starts with grey shade and ends with dark red shade. The lower grade scale colour or the grey shade represents low density areas, whereas the red shade shows high density areas.

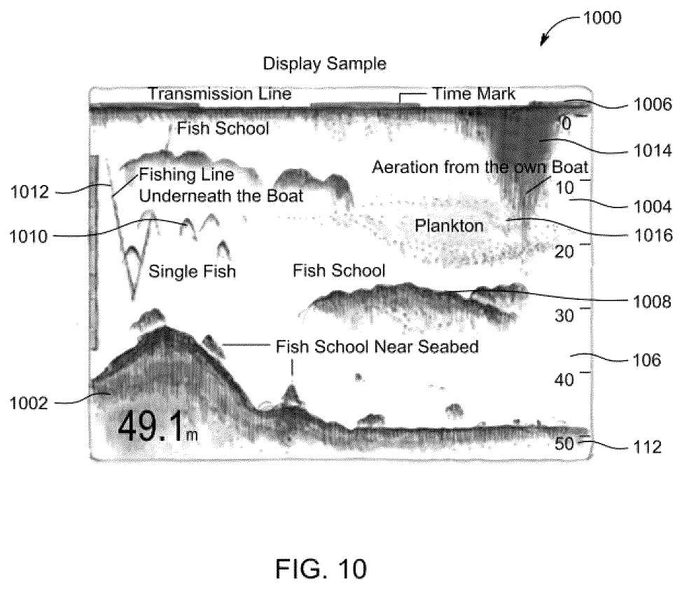

FIG. 11 shows an image 1100 corresponding to an elimination of non-target fish from the detected fishes or the one or more fish schools 110, according to an embodiment of the present disclosure. FIG. 11 is described in conjunction with FIGS. 1-8.

The image 1100 shows presence of multiple fishes with their respective species number. For easy identification of the detection of the at least one target fish, the processing circuitry 312 may assign an identity data, such as an identity number 1102 to every type of fish. It may be noted that the identity data may be any symbol such as a number, a sign, a letter, or a combination thereof. The identity data assigned to each fish in the image 1100, may be different from each other. Hereinafter, the phrases “identity data” and “identity number” may be used interchangeably.

In the example embodiment, the processing circuitry 312 may assign identity number 1102, as 60, 29, 31, 37, 153, etc., to each fish respectively.

The fishes that are marked with cross (shown by 1106) represent non-selected type of fish and the fish without cross mark are the at least one target fish 1108 selected by the user.

Further, in the image 1100, one side shows a scale 1104 depicting the overall depth of the water body 106. By virtue of which, the user may be able to identify the target fish 1108 along with the height or depth at which the target fish 1108 is present.

The processing circuitry 312 keeps the at least one target fish over the user interface 310 and eliminates the remaining types of fishes or the one or more fish schools 110.

Therefore, a final representation of the data after processing does not include unrelated fish species type that are not required by the user.

It may be noted that the at least one target fish that is required by the user may be changed in future after an analyzation has been done by the processing circuitry 312.

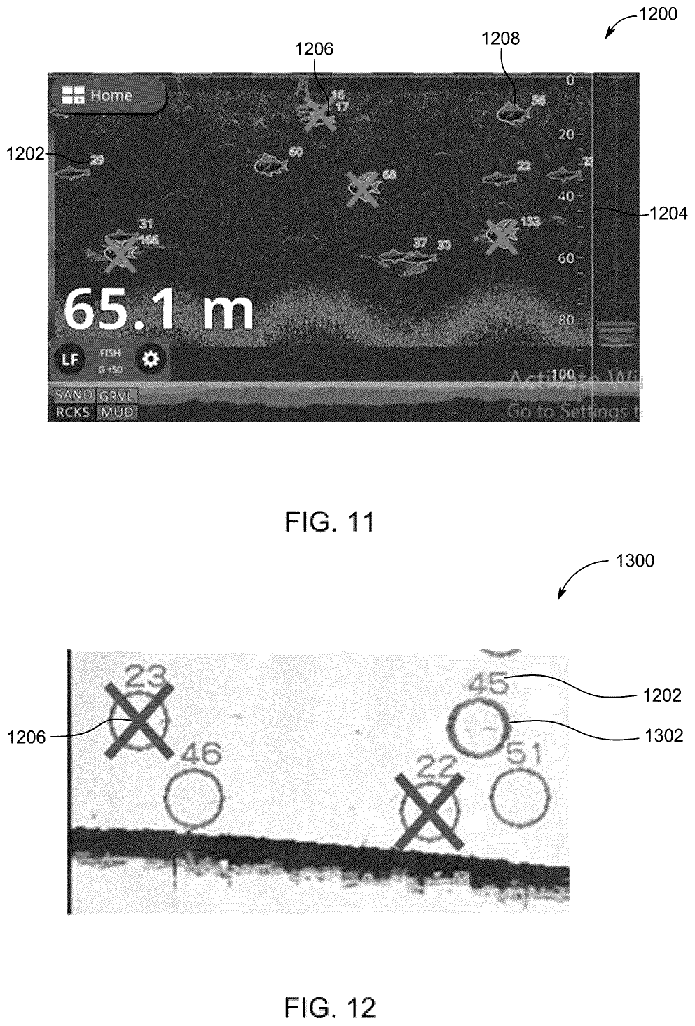

FIG. 12 represents a sample display 1200 of filtered images of the at least one target fish 1108, according to an embodiment of the present disclosure. FIG. 12 is described in conjunction with FIGS. 1-11.

The at least one target fish 1108 detected is represented in circle (shown by 1202). The processing circuitry 312 eliminates the unwanted fish visible (represented by the cross, shown by 1106) and only leaves the at least one target fish 1108. This helps the user to only focus on the required target fish 1108. Further, the target fish 1108 is denoted with the identity number 1102 for easy identification for the user. For example, one of the target fish is given identity number 1102 as “45”.

It may be noted that the cross-marking may be for representation purpose only, without departing from the scope of the disclosure. The non-target fish or the non-target fish schools may be eliminated from the monitor 308, by only representing the at least one target fish 1108 over the monitor 308.

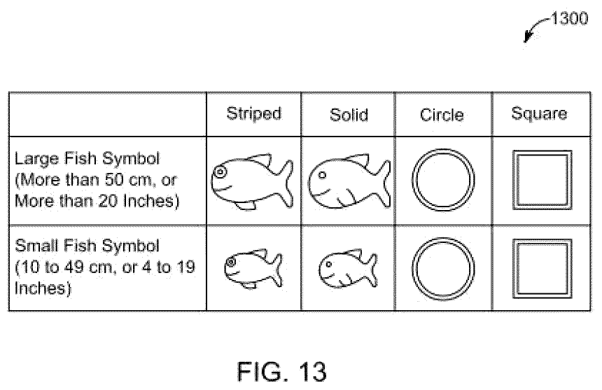

FIG. 13 is a table 1300 representing of fish marks corresponding to fish species, according to an embodiment of the present disclosure.

The processing circuitry 312 designates or assigns a shape in correspondence to each fish species. The table 1300 consists of two rows and four columns. The row includes large fish symbol that is more than 50 cm or more than 50 cm, or more than 20 inches and small fish symbol 10 to 49 cm, or 4 to 19 inches. Based upon the size, the fish may be represented in the striped form, solid form, circle and in square form over the monitor 308.

Further, the fish species may be segregated to help the user to easily distinguish between different size of fish. However, it is still not possible for the user to determine fish species on the basis of species name, water temperature, waterbed 112 type etc. Therefore, the processing circuitry 312 along with the size of the fish, also distinguishes the fishes on the basis of species name, depth of the fish generally found, bottom sediment type, seabed structure, fish school position, size, and water temperature.

The above embodiments are exemplary in all respects and are not restrictive. The scope of the disclosure is set forth in the claims, not in the above description, and includes the meaning of and all variations within the scope of the claims.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiment disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey those certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, movable, fixed, adjustable, and/or releasable connections or attachments. The connections/attachments can include direct connections and/or connections having intermediate structure between the two components discussed.

Unless otherwise explicitly stated, numbers preceded by a term such as “approximately”, “about”, and “substantially” as used herein include the recited numbers, and also represent an amount close to the stated amount that still performs a desired function or achieves a desired result. For example, unless otherwise explicitly stated, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A fish species discrimination system, comprising:
a signal receiver configured to receive a reflection signal from a water body;
a data receiver configured to obtain fish information;
a user interface communicatively coupled to the data receiver, and configured to accept at least one user input related to at least one target fish; and
processing circuitry communicatively coupled to the signal receiver, the data receiver, and the user interface, wherein the processing circuitry is configured to:
measure a depth of the at least one target fish;
measure a size of the at least one target fish; and
generate a display signal based at least on the depth and the size of the at least one target fish.

2. The fish species discrimination system of claim 1, wherein:
the data receiver is further configured to obtain fish species information;
the user interface is further configured to accept at least one user input related to fish species; and
the processing circuitry is further configured to:
discriminate fish species from the fish species information based at least on the depth and the size of the least one target fish; and
generate a display signal based at least on the discrimination.

3. The fish species discrimination system of claim 1, wherein the signal receiver corresponds to a transducer configured to transmit and receive the reflection signal from the water body.

4. The fish species discrimination system of claim 1, wherein the data receiver corresponds to a memory having a fish species database which is configured to store the fish information such as fish species, fish size, and depth.

5. The fish species discrimination system of claim 4, wherein the fish species database is further configured to contain at least one of:
a specific fish icon corresponding to the fish species;
water temperature information at which the fish species live;
area information where the fish species live; and
bottom sediment discrimination information where the fish species live.

6. The fish species discrimination system of claim 4, wherein the data receiver corresponds to a communicator configured to receive the fish information from the fish species database via a network.

7. The fish species discrimination system of claim 6, wherein the network is at least one of Long Term Evolution (LTE), 5G, 6G, National Marine Electronics Association (NMEA) bus, Controller Area Network (CAN) Bus, Local Area Network (LAN), Internet, Wireless Fidelity (Wi-Fi), and satellite communication.

8. The fish species discrimination system of claim 4, wherein the fish species database is configured to be updated periodically, automatically, or randomly, using artificial intelligence or machine learning technology.

9. The fish species discrimination system of claim 4, wherein the fish species database is configured to be updated manually based at least on a user input via the network.

10. The fish species discrimination system of claim 1, wherein the at least one user input comprises at least one of depth and size of the at least one target fish.

11. The fish species discrimination system of claim 1 is, a fish finder or a Sound navigation and Ranging (SONAR).

12. The fish species discrimination system of claim 1, is configured to perform learning process for discriminating the fish species and identifying the fish species.

13. A method for discriminating fish species, the method comprising:
receiving a reflection signal from a water body, using a signal receiver;
obtaining fish information from a data receiver;
accepting at least one user input related to at least one target fish;
measuring a depth of the at least one target fish;
measuring a size of the at least one target fish;
generating a display signal based at least on the depth and the size of the at least one target fish.

14. The method for discriminating fish species of claim 13, further comprising:
receiving fish species information from the data receiver;
receiving at least one user input related to fish species;
discriminating fish species from the fish species information based at least on the depth and the size of the least one target fish
generating a display signal based at least on the discrimination.

15. The method for discriminating fish species of claim 13, wherein the signal receiver corresponds to a transducer configured to transmit and receive the reflection signal from the water body.

16. The method for discriminating fish species of claim 13, wherein the data receiver corresponds to a memory having a fish species database which is configured to store the fish information such as fish species, fish size, and depth.

17. The method for discriminating fish species of claim 16, wherein the fish species database is further configured to contain at least one of:
a specific fish icon corresponding to the fish species;
water temperature information at which the fish species live;
area information where the fish species live; and
bottom sediment discrimination information where the fish species live.

18. The method for discriminating fish species of claim 16, wherein the data receiver corresponds to a communicator configured to receive the fish information from the fish species database via a network.

19. The method for discriminating fish species of claim 13, wherein the at least one user input comprises at least one of depth and size of the at least one target fish.

20. A non-transitory computer readable medium storing instruction that, when executed by processing circuitry, cause a computer system to perform a method that comprises:
receiving a reflection signal from a water body, using a signal receiver;
obtaining fish information from a data receiver;
accepting at least one user input related to at least one target fish;
measuring a depth of the at least one target fish;
measuring a size of the at least one target fish; and
generating a display signal based at least on the depth and the size of the at least one target fish.
